(19) United States
(12) Patent Application Publication
(10) Pub. No.: US 2004/0155984 A1
(43) Pub. Date: Aug. 12, 2004

(54) Multiple signal input device of decoder ASIC in DTV system

(76) Inventor: Seung Hyeon Rhee, Seoul (KR)

Correspondence Address: BIRCH STEWART KOLASCH & BIRCH, PO BOX 747, FALLS CHURCH, VA, 22040-0747, US

(21) Appl. No.: 10/745,661

(22) Filed: Dec. 29, 2003

(30) Foreign Application Priority Data
Dec. 26, 2002 (KR) P2002-84435

(51) Int. Cl. H04N 3/27; H04N 5/268

(52) U.S. Cl. 348/705; 710/105; 348/554

(57) ABSTRACT

A multiple signal input device of a decoder ASIC in a DTV system, having a plurality of internal decoders decoding a plurality of signals inputted from a plurality of input ports, is disclosed, which includes the plurality of input ports having the same function; and a plurality of internal multiplexers respectively provided for being corresponding to the plurality of internal decoders between the input ports and the internal decoders, and selectively outputting a predetermined signal among signals inputted by the plurality of input ports according to a control signal, wherein, each input terminal of the internal multiplexers is electrically connected with the plurality of input ports, and each output terminal of the internal multiplexers is electrically connected with one corresponding internal decoder.

This application claims the benefit of the Korean Application No. P2002-84435, filed on Dec. 26, 2002, which is hereby incorporated by reference.

### BACKGROUND OF THE INVENTION

1. Field of the Invention

The present invention relates to a DTV system, and more particularly, to a multiple signal input device of a decoder ASIC in a DTV system.

2. Discussion of the Related Art

Recently, many products relating to a DTV system emphasize a function that a user selects and watches several channels simultaneously. This function is already obtained in an analog system. With new types of digital products having various functions, this function has been emphasized in the DTV system. Especially, as a personal video recorder (PVR) and a digital video disk (DVD) are integrated with the DTV system, or functions of PIP/POP using an external input are added to the DTV system, it is necessary for the DTV system to receive various data simultaneously. Thus, it is required that a channel data input part of a decoder in the DTV system receives at least two channels simultaneously, and receives data input from different input signal sources.

Meanwhile, an application specific integrated circuit (ASIC) serving for this function requires large numbers of input/output ports so as to support various functions, whereby the size of chip increases, thereby increasing the cost of product. Accordingly, there is a need for developing a decoder ASIC of the DTV system to prevent the size of chip from increasing, and to minimize the number of input/output ports with support of various functions.

In due consideration of the cost and period for developing the ASIC of the DTV system, it is general to develop the ASIC integrating the various functions therein. Generally, the ASIC of the DTV system, which supports ATSC, DIRECTV and DVD, is a typical example of a common use. In this case, ATSC and DIRECTV are employed as the standard terrestrial and satellite broadcasting, respectively, in North America, and DVD is employed as a worldwide application for digital storage media.

FIG. 1 illustrates the most simplified structure of the channel data input part of the ASIC 100. However, it is unusual to design the ASIC supporting all three functions in the DTV system. As shown in FIG. 2A and FIG. 2B, it is general to design the ASIC supporting some functions of ATSC/DIRECTIVE or ATSC/DVD. Accordingly, even though the DTV system having the three functions includes three input ports, only two input ports are practically used in the circuit, whereby it is hard to assign the input ports effectively, thereby increasing the size of chip.

### SUMMARY OF THE INVENTION

Accordingly, the present invention is directed to a multiple signal input device of a decoder ASIC in a DTV system that substantially obviates one or more problems due to limitations and disadvantages of the related art.

An object of the present invention is to provide a multiple signal input device of a decoder ASIC in a DTV system to decrease the size of chip by minimizing the number of input ports.

Another object of the present invention is to provide a multiple signal input device of a decoder ASIC in a DTV system to receive data from many sources, with the minimized number of input ports, thereby improving efficiency of input port.

Another object of the present invention is to provide a multiple signal input device of a decoder ASIC in a DTV system, wherein, when a user wants to change one channel during watching a plurality of channels, or wants to additionally activate another channel during watching one channel, it is possible to have no effect on the unchanged channel.

Another object of the present invention is to provide a multiple signal input device of a decoder ASIC in a DTV system to control all internal and external multiplexers with an internal control signal provided in the inside of an ASIC.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a multiple signal input device of a decoder ASIC in a DTV system, having a plurality of internal decoders decoding a plurality of signals inputted from a plurality of input ports, includes the plurality of input ports having the same function; and a plurality of internal multiplexers respectively provided for being corresponding to the plurality of internal decoders between the input ports and the internal decoders, and selectively outputting a predetermined signal among signals inputted by the plurality of input ports according to a control signal, wherein, each input terminal of the internal multiplexers is electrically connected with the plurality of input ports, and each output terminal of the internal multiplexers is electrically connected with one corresponding internal decoder.

At this time, the external signals of the same kind are enabled to input to the input ports, and the external signal inputted to the respective input ports is any one of an ATSC signal, a DIRECTV signal, and a DVD signal.

Also, any one of the input ports is a fixed port, and the other is a change port. Herein, the number of the input ports is smaller than the number of the internal multiplexers.

Also, the internal multiplexers are in a one-to-one correspondence with the internal decoders. The internal decoders corresponding to the respective internal multiplexers are an ATSC decoder, a DIRECTV decoder and a DVD decoder.

In another aspect, a multiple signal input device of a decoder ASIC in a DTV system, having a plurality of internal decoders decoding signals inputted from a plurality of input ports, includes the plurality of input ports having the same function; a plurality of internal multiplexers respectively provided for being corresponding to the plurality of internal decoders between the input ports and the internal decoders, and selectively outputting a predetermined signal among signals inputted by the plurality of input ports according to a control signal, wherein, each input terminal of the internal multiplexers is electrically connected with the plurality of input ports, and each output terminal of the internal multiplexers is electrically connected with one corresponding internal decoder; and a plurality of external multiplexers respectively provided for being corresponding to the plurality of input ports, and selectively outputting a predetermined signal among signals inputted by a control signal, wherein, each input terminal of the external multiplexers is electrically connected with the plurality of external signal sources, and each output terminal of the external multiplexers is electrically connected with one corresponding input port.

At this time, the device further includes a control part generating the control signal inputted to the external and internal multiplexers.

The control part includes a multiplexer control register generating the control signal; an input signal selector selecting any one among the plurality of input signals according to the control signal generated in the multiplexer control register; a binary decoder decoding the signal selected by the input signal selector; a GPIO data output register outputting a GPIO data signal; a mode select register generating a mode select control signal; and a control signal multiplexer receiving a port select control signal decoded by the binary decoder, and the GPIO data signal outputted from the GPIO data output register, and outputting the port select control signal or the GPIO data signal according to the control signal outputted from the mode select register.

At this time, the control signal generated in the multiplexer control register is inputted to the internal multiplexer, and the port select control signal outputted from the control signal multiplexer is inputted to the external multiplexer.

The external signal source is any one of ATSC, DIRECTV and DVD, and the external signals of the same kind are enabled to input to the input ports.

Also, the internal multiplexers are in a one-to-one correspondence with the internal decoders, and the external multiplexers are in a one-to-one correspondence with the input ports.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 and FIG. 2A and FIG. 2B illustrate a multiple signal input device of a decoder ASIC in a DTV system according to the related art;

FIG. 3 illustrates a multiple signal input device of a decoder ASIC in a DTV system according to the present invention;

FIG. 4 to FIG. 6 illustrate examples of signal flow in a multiple signal input device according to the present invention;

FIG. 7A and FIG. 7B illustrate another embodiment according to the present invention; and

FIG. 8 illustrates a control part for applying a control signal to an external multiplexer according to the present invention.

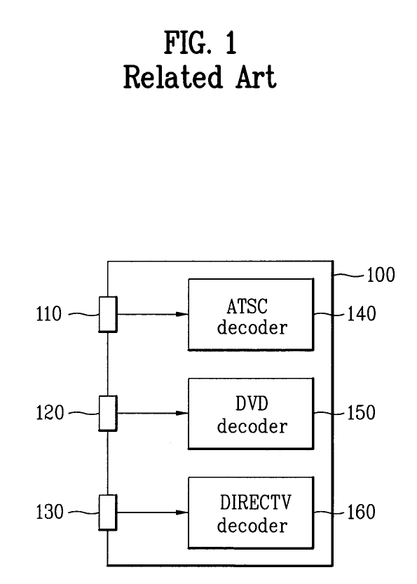

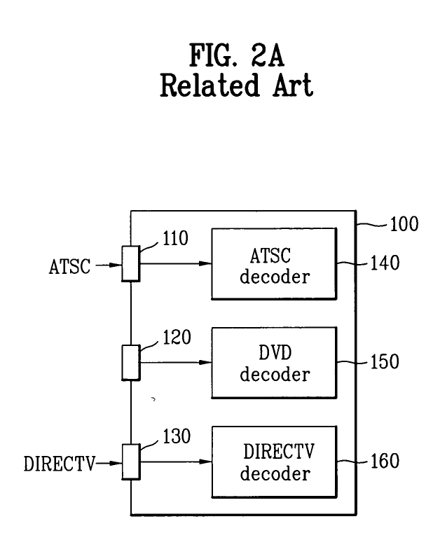

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a multiple signal input device of a decoder ASIC in a DTV system according to the present invention will be described with reference to the accompanying drawings.

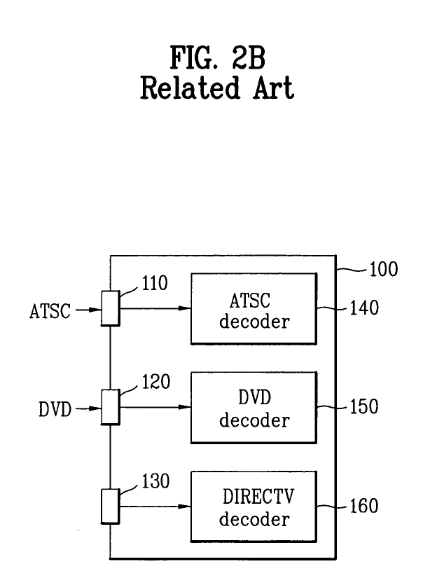

FIG. 3 illustrates a multiple signal input device of a decoder ASIC in a DTV system according to the present invention. As shown in FIG. 3, the multiple signal input device of the decoder ASIC in the DTV system according to the present invention includes a plurality of input ports 110 and 120, a plurality of internal multiplexers 310, 320 and 330 provided in the inside of the decoder ASIC, and a plurality of external multiplexers 400 and 500 provided in the outside of the decoder ASIC.

In this state, the respective input ports 110 and 120 have the same function. That is, external signals of the same kind are enabled to input to the input ports 110 and 120. For example, the external signal inputted to the respective input ports 110 and 120 may be any one of an ATSC signal, a DIRECTV signal, and a DVD signal. Also, any one of the input ports 110 and 120 is a fixed port, and the other is a change port. Herein, the number of the input ports may be smaller than the number of the internal multiplexers.

In the preferred embodiment of the present invention, the application specific integrated circuit (ASIC) 100 supports ATSC, DIRECTV and DVD. Accordingly, it is possible that the ASIC 100 receives the ATSC signal, the DIRECTIVE signal and the DVD signal. Then, the plurality of internal multiplexers 310, 320 and 330 are respectively provided for being corresponding to a plurality of internal decoders 140, 150 and 160 between the input ports 110 and 120 and the internal decoders 140, 150 and 160. Herein, the respective internal decoders 140, 150 and 160 decode signals inputted from the plurality of input ports 110 and 120.

Subsequently, each input terminal of the internal multiplexers 310, 320 and 330 is electrically connected with the plurality of input ports 110 and 120, and each output terminal of the internal multiplexers 310, 320 and 330 is electrically connected with one corresponding internal decoder. That is, the internal multiplexers 310, 320 and 330 are in a one-to-one correspondence with the internal decoders 140, 150 and 160, whereby it is possible to selectively output a predetermined signal among the signals inputted through the plurality of input ports 110 and 120 according to a control signal.

In the preferred embodiment of the present invention, since the ASIC 100 supports the ATSC, DIRECTV and DVD, the internal decoders 140, 150 and 160 are respectively corresponding to an ATSC decoder, a DIRECTV decoder and a DVD decoder. Also, the external multiplexers 400 and 500 are respectively provided for being corresponding to the input ports 110 and 120, whereby it is possible to selectively output a predetermined signal among the signals inputted by the control signal. In this case, each input terminal of the external multiplexers 400 and 500 is electrically connected with a plurality of external signal sources, and each output terminal of the external multiplexers 400 and 500 is electrically connected with one corresponding input port 110 and 120.

In the preferred embodiment of the present invention, the external signal source is any one of ATSC, DIRECTV and DVD, and the respective external multiplexers 400 and 500 are electrically connected with an ATSC signal source, a DIRECTV signal source and a DVD signal source.

Although not shown, a control part generates and inputs the control signal to the external multiplexers 400 and 500 and the internal multiplexers 310, 320 and 330. The control part may have two separate controllers, in which one is for inputting the control signal to the external multiplexers 400 and 500, and the other is for inputting the control signal to the internal multiplexers 310, 320 and 330. Or, the control part may have one controller for inputting the control signal to the external and internal multiplexers.

Hereinafter, the control part will be described in more detail.

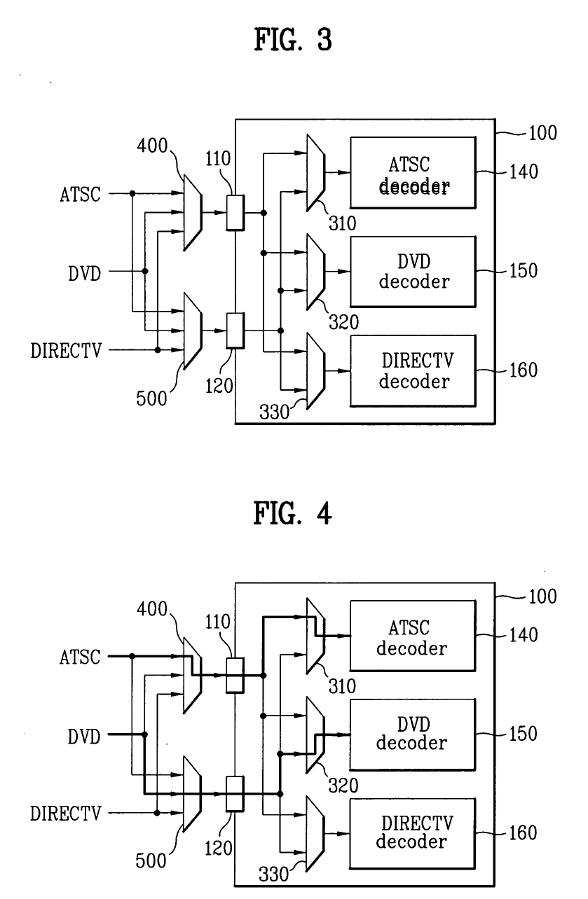

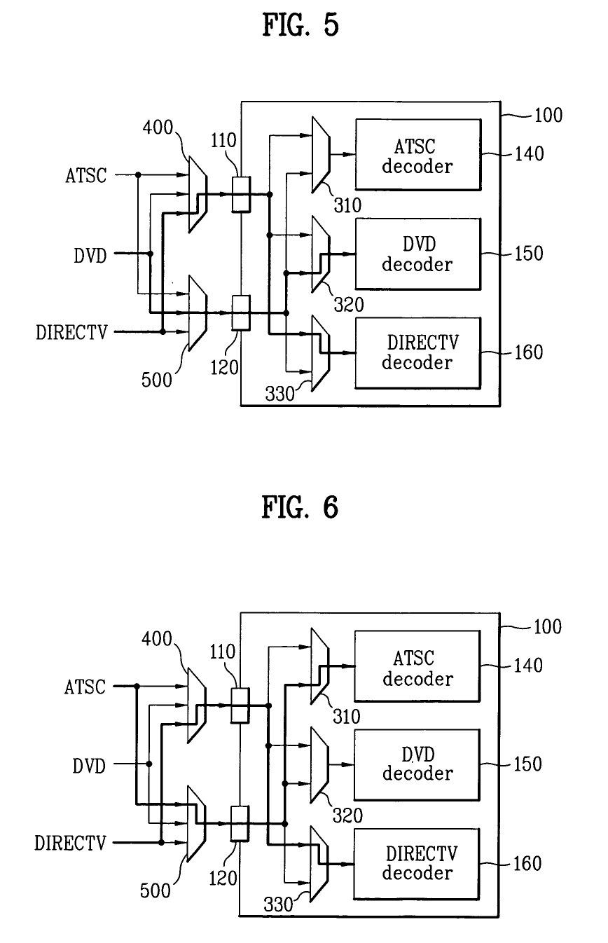

FIG. 4 to FIG. 6 illustrate examples of signal flow in a multiple signal input device according to the present invention. As shown in FIG. 4 and FIG. 5, when the channel combination is changed from ATSC and DVD to DIRECTV and DVD, it is possible to effectively perform a signal input process in the multiple signal input device according to the present invention.

In this case, the DVD signal is set as a fixed channel, and the DVD signal is inputted to the input port 120. Then, the ATSC signal is set as a change channel, and the DIRECTV signal, instead of the ATSC signal, is inputted to another input port 110. Subsequently, the DIRECTV signal inputted through the input port 110 is inputted to the DIRECTV decoder 160 by the internal multiplexer 330. Accordingly, in the multiple signal input device according to the present invention, the external multiplexers 400 and 500 are controlled separately from the internal multiplexers 310, 320 and 300, whereby the DVD channel maintains the connection between the external input signal sources provided outside the ASIC 100 and the internal decoders 140, 150 and 160 without any effect from the change of the other channel.

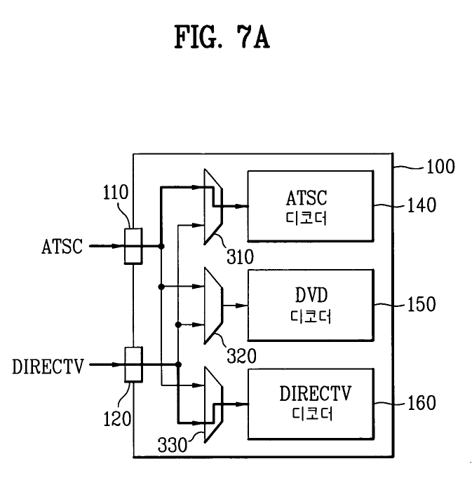

As shown in FIG. 6, when it is required that the channel combination is changed from DIRECTV and DVD to ATSC and DIRECTV, the process will be progressed as follows.

The DIRECTV signal is set as a fixed channel, and the DIRECTV signal is inputted to the input port 110. Then, the DVD is set as a change channel, and the ATSC signal, instead of the DVD signal, is inputted to another input port 120. Subsequently, the ATSC signal inputted through the input port 120 is inputted to the ATSC decoder 140 by the internal multiplxer 310. Accordingly, it is possible to solve the problem regarding assignment of the input ports to the various input signal sources. That is, in the multiple signal input device according to the present invention, it is possible to receive and progress the various signals with the small number of input ports. In addition, when a user wants to change one channel during watching a plurality of channels, or wants to additionally activate another channel during watching one channel, it is possible to have no effect on the unchanged channel.

Also, in the multiple signal input device according to the present invention, it is possible to obtain the simplified structure in case the number of input signal sources is same as the number of input ports. In this case, since the external multiplexers are not used in the circuit according to the present invention, the structure thereof is simplified.

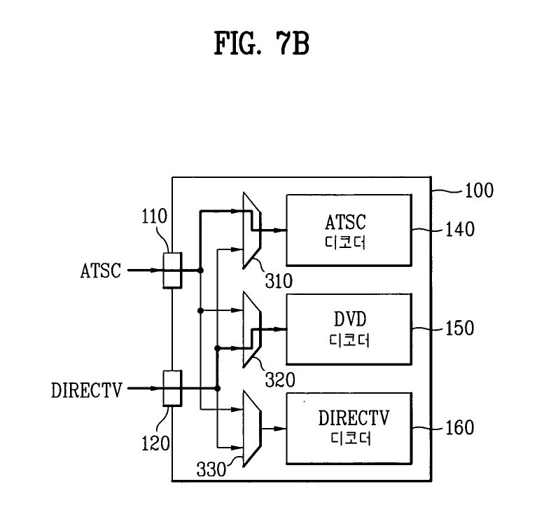

FIG. 7A and FIG. 7B illustrate another embodiment of the present invention.

FIG. 7A illustrates a system supporting a channel combination of ATSC and DIRECTV, and FIG. 7B illustrates a system supporting a channel combination of ATSC and DVD. As shown in FIG. 7A and FIG. 7B, in case the number of input signal sources is the same as the number of corresponding input ports, the circuit structure is simplified since the external multiplexers are not used in the circuit. Accordingly, the internal multiplexers 310, 320 and 330 selectively output the predetermined input signal.

As shown in FIG. 3, FIG. 7A and FIG. 7B, if the multiplexers are used in the circuit, it is required to use the control signal for selecting the predetermined signal among the input signals. That is, in order to connect a predetermined external signal source provided in the outside of the ASIC to a predetermined internal decoder provided in the inside of the ASIC, it is necessary to output an internal multiplexer control signal determining which of input ports 110 and 120 to connect the internal decoders 140, 150 and 160, and an external multiplexer control signal determining which of external signal sources to connect the corresponding input port.

In general, the external multiplexer control signal is generated from a value of the internal multiplexer control signal. In this case, only register for setting the internal multiplexer control signal is required. For example, as shown in FIG. 3, when the register for controlling the internal multiplexer connected with the ATSC decoder 140 is set as the input port 110, the external multiplexer control signal for the input port 110 is automatically determined as the ATSC signal source. Accordingly, the external ATSC signal source is connected with the internal ATSC decoder 140.

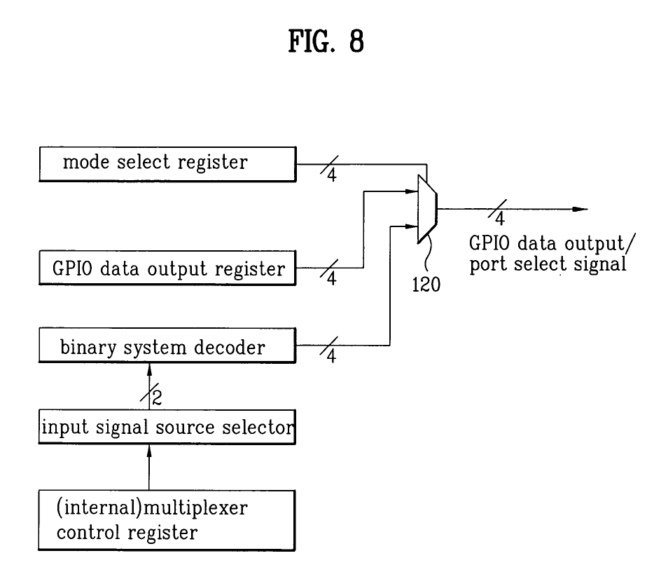

In this case, it has no problem regarding the control of the internal multiplexer provided in the ASIC 100. However, in case of the external multiplexers 400 and 500, it is required to progress an additional process for controlling the external multiplexers 400 and 500 since the control register is provided in the inside of the ASIC 100 and the external multiplexers 400 and 500 are provided in the outside of the ASIC 100. For this, as shown in FIG. 8, a General Purpose Input Output (GPIO) is used as two modes. One is the normal GPIO mode, and the other is the control signal mode for the external multiplexer.

FIG. 8 illustrates a control part for applying a control signal to an external multiplexer according to the present invention. In FIG. 8, four input signal sources are provided. As shown in FIG. 8, the control part includes a multiplexer control register, an input signal selector, a binary decoder, a GPIO data output register, a mode select register, and a GPIO data output multiplexer 120. At this time, the multiplexer control register generates a control signal, and the input signal selector selects any one of a plurality of signals inputted according to the control signal generated in the multiplexer control register. Also, the binary decoder decodes the signal selected by the input signal selector.

Then, the GPIO data output register outputs the GPIO data signal, and the mode select register generates a mode select control signal. The GPIO data output multiplexer 120 receiving a port select control signal decoded by the binary decoder, and the GPIO data signal outputted from the GPIO data output register selectively outputs the port select control signal or the GPIO data signal according to the control signal from the mode select register. The control signal generated in the internal multiplexer control register is inputted to the internal multiplexer, and the port select control signal outputted from the GPIO data output multiplexer 120 is inputted to the external multiplexer.

The control part having the aforementioned structure is operated as follows.

Supposing the input ports are two, the internal multiplexer control signal has a value of ‘0’ or ‘1’, whereby a value for selecting one from four input signal sources is generated between ‘0’ and ‘3’. By using the binary decoder receiving the corresponding value, it is possible to change the value to a signal of 4 bits. The changed value is used as the port select control signal of the external multiplexer.

In this case, the port select control signal and the GPIO signal use the same pin in common. Thus, the mode select register is required to determine whether the pin is used for the GPIO data signal or the port select control signal of the external multiplexer. The mode select register is operated as GP_IN mode in case a field corresponding to each bit of the GPIO data signal is ‘00’, the mode select register is operated as GP_OUT mode in case a field is ‘01’, and the mode select register is operated as the external multiplexer control signal mode in case a field is ‘11’.

When a power-on reset value of the mode select register is ‘0’, a basic mode of each bit is GP_IN mode. Then, the mode is set according to each bit, whereby the unused bit among 4 bits may be used for the GPIO. For example, if the ASIC 100 support four input signal sources from ‘0’ to ‘3’, and the system uses the signal sources corresponding to ‘0’, ‘2’ and ‘3’, the multiplexer control signal corresponding to 1 bit is not required. Thus, the unused bit ‘1’ may be set as the GPIO mode.

Accordingly, the multiple signal input device according to the present invention may be used in the related art system and method, and it is possible to design the multiple signal input device according to the present invention in various methods if necessary.

As mentioned above, the multiple signal input device of the decoder ASIC in the DTV system according to the present invention has the following advantages.

First, it is possible for the decoder blocks provided in inside of the ASIC to select the data inputted from all input ports, so that it is possible to support all signal sources in the system using the larger number of input signal sources than the number of input ports of the ASIC.

Also, when the channel combination is changed, it is possible to release and reconnect only input sources to be removed and addes, respectively, whereby the other channels are maintained without any effect thereon during changing the desired channel.

The external multiplexer control signal connected with the input port is generated in the inside of the ASIC, so that the multiplexer is controlled with easiness and safety. Also, it is possible to selectively use the corresponding function without increase in the number of pins since the pin is used for both the multiplexer control signal and the GPIO port.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A multiple signal input device of a decoder ASIC in a DTV system, having a plurality of internal decoders decoding a plurality of signals inputted from a plurality of input ports, comprising:
the plurality of input ports having the same function; and
a plurality of internal multiplexers respectively provided for being corresponding to the plurality of internal decoders between the input ports and the internal decoders, and selectively outputting a predetermined signal among signals inputted by the plurality of input ports according to a control signal, wherein, each input terminal of the internal multiplexers is electrically connected with the plurality of input ports, and each output terminal of the internal multiplexers is electrically connected with one corresponding internal decoder.

2. The device as claimed in claim 1, wherein the input ports are functionally the same. That is, one port can accept every kind of signals that the other(s) can.

3. The device as clamed in claim 2, wherein the external signal inputted to the respective input ports is any one of an ATSC signal, a DIRECTV signal, and a DVD signal.

4. The device as claimed in claim 1, wherein any one of the input ports is a fixed port, and the other is a change port.

5. The device as clamed in claim 1, wherein the number of the input ports is smaller than the number of the internal multiplexers.

6. The device as claimed in claim 1, wherein the internal multiplexers are in a one-to-one correspondence with the internal decoders.

7. The device as claimed in claim 6, wherein the internal decoders corresponding to the respective internal multiplexers are an ATSC decoder, a DIRECTV decoder and a DVD decoder.

8. The device as claimed in claim 1, further comprising a control part generating the control signal inputted to the internal multiplexer.

9. The device as claimed in claim 1, further comprising a plurality of external multiplexers provided for being corresponding to the plurality of input ports, and selectively outputting a predetermined signal among signals inputted by the plurality of input ports according to a control signal, wherein, each input terminal of the external multiplexers is electrically connected with a plurality of external signal sources, and each output terminal of the external multiplexers is electrically connected with one corresponding input port.

10. The device as claimed in claim 9, wherein the external multiplexers are in a one-to-one correspondence with the input ports.

11. A multiple signal input device of a decoder ASIC in a DTV system, having a plurality of internal decoders decoding signals inputted from a plurality of input ports, comprising:
the plurality of input ports having the same function;
a plurality of internal multiplexers respectively provided for being corresponding to the plurality of internal decoders between the input ports and the internal decoders, and selectively outputting a predetermined signal among signals inputted by the plurality of input ports according to a control signal, wherein, each input terminal of the internal multiplexers is electrically connected with the plurality of input ports, and each output terminal of the internal multiplexers is electrically connected with one corresponding internal decoder; and
a plurality of external multiplexers respectively provided for being corresponding to the plurality of input ports, and selectively outputting a predetermined signal among signals inputted by a control signal, wherein, each input terminal of the external multiplexers is electrically connected with the plurality of external signal sources, and each output terminal of the external multiplexers is electrically connected with one corresponding input port.

12. The device as claimed in claim 11, further comprising a control part generating the control signal inputted to the external and internal multiplexers.

13. The device as claimed in claim 12, wherein the control part includes:
a multiplexer control register generating the control signal;
an input signal selector selecting any one among the plurality of input signals according to the control signal generated in the multiplexer control register;
a binary decoder decoding the signal selected by the input signal selector;
a GPIO data output register outputting a GPIO data signal;
a mode select register generating a mode select control signal; and
a GPIO data output multiplexer receiving a port select control signal decoded by the binary decoder, and the GPIO data signal outputted from the GPIO data output register, and outputting the port select control signal or the GPIO data signal according to the control signal outputted from the mode select register.

14. The device as claimed in claim 13, wherein the control signal generated in the multiplexer control register is inputted to the internal multiplexer, and the port select control signal outputted from the GPIO data output multiplexer is inputted to the external multiplexer.

15. The device as claimed in claim 11, wherein the external signal source is any one of ATSC, DIRECTV and DVD.

16. The device as claimed in claim 11, wherein the input ports are functionally the same. That is, one port can accept every kind of signals that the other(s) can.

17. The device as claimed in claim 16, wherein the external signal inputted to the input ports is any one of ATSC, DRECTV and DVD signals.

18. The device as claimed in claim 11, wherein any one of the input ports is a fixed port, and the other is a change port.

19. The device as claimed in claim 11, wherein the number of input ports is smaller than the number of internal multiplexers.

20. The device as claimed in claim 11, wherein the internal multiplexers are in a one-to-one correspondence with the internal decoders, and the external multiplexers are in a one-to-one correspondence with the input ports.

21. The device as claimed in claim 20, wherein the internal decoders corresponding to the respective internal multiplexers are ATSC, DIRECTV and DVD decoders.

22. The device as claimed in claim 11, wherein each external multiplexer is connected with ATSC, DIRECTV and DVD signal sources.
